(19) United States
(12) Patent Application Publication
(10) Pub. No.: US 2011/0108525 A1
(43) Pub. Date: May 12, 2011

(54) METHOD AND SYSTEM FOR MANUFACTURING MICROSTRUCTURE IN PHOTOSENSITIVE GLASS SUBSTRATE

(75) Inventors: Chih-Wei CHIEN, Hsinchu (TW); Chung-Wei Cheng, Hsinchu (TW); Ping-Xiang Li, Hsinchu (TW); Jeng-Shyong Chen, Hsinchu (TW)

(73) Assignee: INDUSTRIAL TECHNOLOGY RESEARCH INSTITUTE, Hsinchu (TW)

(21) Appl. No.: 12/768,859

(22) Filed: Apr. 28, 2010

(30) Foreign Application Priority Data
Nov. 11, 2009 (TW) 098138200

(51) Int. Cl. B44C 1/22; C23F 1/08

(52) U.S. Cl. 216/87; 156/345.1

(57) ABSTRACT

The present invention provides a method and system for manufacturing a microstructure in a photosensitive glass substrate, which include the steps of generating first femtosecond laser pulses by a femtosecond laser source and focusing the first femtosecond laser pulses on a surface or an interior of the photosensitive glass substrate by a focus lens to define a modified region; generating second femtosecond laser pulses by the femtosecond laser source, adjusting a frequency of the second femtosecond laser pulses to be higher than that of the first femtosecond laser pulses by a frequency adjustment unit and an energy adjustment unit; focusing the adjusted second femtosecond laser pulses on the modified region of the photosensitive glass substrate to crystallize a substance of the modified region; and, after crystallization, etching off the crystallized region to obtain the microstructure in the photosensitive glass substrate.

### TECHNICAL FIELD

The present invention relates to the manufacture of a microstructure in a photosensitive glass substrate, and more particularly to a method and a system for manufacturing a microstructure in a photosensitive glass substrate by a femtosecond laser.

### BACKGROUND

Photosensitive glass is substance with high transparency, high hardness, high chemical resistance and high heat resistance. Because the glass is doped with specific metal elements, the absorbance thereof to radiation with a wavelength between 250 to 350 nm is high. Therefore, the photosensitive glass is usually used in the manufacture of biochips and glass inserts.

To manufacture microstructures on surfaces of the photosensitive glass substrates, the typical process includes the following steps: modifying specific regions of the photosensitive glass substrates by exposure and development processes; tempering the entire photosensitive glass substrates in a heating furnace to produce crystals in the modified regions; and etching off the crystal-containing modified regions (also called crystallized regions in the present application) by acid solutions to obtain microstructures of photosensitive glass substrate (due to the phenomenon that the speed of the crystallized regions responsive to the acid solutions is 20-40 times faster than that of the non-crystallized regions). However, common exposure and development processes can only form microstructures on the surfaces of the photosensitive glass substrates; and, when performing the temper treatment in the heating furnace, unnecessary deformation happens in the unmodified regions of the photosensitive glass substrates due to heating. In addition, it takes several hours to perform the temper treatment in the heating furnace. That is inconvenient in use and is time-consuming.

U.S. Pat. Nos. 5,314,522, 7,029,806, 6,692,885, 7,018,259, 7,132,054, 5,374,291 and 7,041,229 disclose that the exposure process is performed with a photomask under a UV radiation having a wavelength of about 300 nm. However, the method disclosed in the above patents still needs the temper treatment in the heating furnace. As such, the above-mentioned problems can not be overcome.

U.S. Pat. No. 7,033,519 discloses a method containing the following steps: modifying the surfaces and the interior of the photosensitive dielectric substances by a femtosecond laser; tempering in a heating furnace; and etching. The method disclosed in that patent reduces the time for modification or exposure and improves precision of structures, but the step of tempering in the heating furnace still causes the deformation of the unmodified regions, such that the yield of the process cannot be increased.

Hence, there is an urgent demand to avoid the deformation of the unmodified regions caused by the temper treatment and to improve the alignment precision.

### SUMMARY

In view of the shortcomings of the above prior art, the present invention provides a method for manufacturing a microstructure in a photosensitive glass substrate, wherein the method comprises: focusing first femtosecond laser pulses on a surface or the interior of the photosensitive glass substrate to define a modified region; focusing second femtosecond laser pulses, which have a frequency higher than that of the first femtosecond laser pulses, on the modified region to crystallize a substance in the modified region; and, after the step of focusing second femtosecond laser pulses, etching off the crystallized region to obtain the microstructure.

In this method, preferably, the first femtosecond laser pulses and the second femtosecond laser pulses of the present invention are generated by a femtosecond laser source, wherein pulse widths of the first femtosecond laser pulses and the second femtosecond laser pulses are smaller than or equivalent to 500 fs.

In one embodiment, the frequency of the second femtosecond laser pulses conforms to the following formula:

f≧Dₜ/d², wherein f is the frequency of the second femtosecond laser pulses, Dₜ is a thermal diffusion coefficient of the photosensitive glass substrate and d is a diameter of a laser spot of the second femtosecond laser pulses focused on the photosensitive glass substrate.

In addition, the present invention provides a system for manufacturing a microstructure in a photosensitive glass substrate, wherein the system comprises: a carrier for loading the photosensitive glass substrate; a femtosecond laser source for generating femtosecond laser pulses; a frequency adjustment unit configured along a transmission path of the femtosecond laser pulses to adjust the frequency of the femtosecond laser pulses; an energy adjustment unit configured along the transmission path of the femtosecond laser pulses to adjust energy of the femtosecond laser pulses; and a focus lens for focusing the femtosecond laser pulses with adjusted frequency and energy on a surface or the interior of the photosensitive glass substrate loaded on the carrier.

In one embodiment, the system of the present invention further includes a movement control mechanism, which is connected to the carrier to move the carrier relative to the femtosecond laser pulses.

In another embodiment, the movement control mechanism of the present invention is connected to the femtosecond laser source to allow the femtosecond laser pulses moving relative to the carrier to form a modified pattern and a crystallized pattern.

Compared with the prior art, second femtosecond laser pulses of the present invention that have a frequency higher than that of the femtosecond laser pulses used to form the modified region is focused on the modified region to perform a local tempering treatment, such that the unmodified region of the present invention does not deform due to the heating. Moreover, an ideal microstructure can be obtained after etching because the focused femtosecond laser pulses have high alignment precision and the non-focused region of the photosensitive glass substrate is not treated and is not crystallized. Therefore, the present invention has the advantages of reducing the steps and time in the process and obtaining the microstructure with high precision.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a schematic diagram showing a system for manufacturing a microstructure in a photosensitive glass substrate according to an embodiment of the present invention;

FIG. 1B is a schematic diagram showing a system for manufacturing a microstructure in a photosensitive glass substrate according to another embodiment of in the present invention;

FIG. 2A is a schematic diagram showing a system for manufacturing a microstructure in a photosensitive glass substrate that has a movement control mechanism according to a further embodiment of the present invention;

FIG. 2B is a schematic diagram showing a system for manufacturing a microstructure in a photosensitive glass substrate that has a movement control mechanism according to still another embodiment of the present invention;

FIG. 3A shows a picture (from an optical microscope) of a surface microstructure in a photosensitive glass substrate manufactured according to an embodiment of the present invention;

FIG. 3B shows a picture (from an optical microscope) of a microstructure that is not manufactured under the conditions of the present invention;

FIG. 4 shows a cross-section diagram of portions of a photosensitive glass substrate being treated according to an embodiment of the method of the present invention; and

FIGS. 5A and 5B show pictures (from an optical microscope) of a blind via of the photosensitive glass substrates and the micro-channel thereof in the present invention, wherein FIG. 5B shows the thinnest part of about 5 μm in the middle section of the micro-channel.

### DETAILED DESCRIPTION OF THE PREFERRED EMBODIMENTS

The following illustrative embodiments are provided to illustrate the disclosure of the present invention. Those in the art will be able understand other advantages and effects of the present invention after reading the disclosure of this specification.

The present invention relates to a method for manufacturing a microstructure in a photosensitive glass substrate by a femtosecond laser. In the present invention, the photosensitive glass substrate can be modified and tempered by the same laser source to obtain a crystallized pattern. In another aspect, the subject to be treated by the present invention is a photosensitive glass substrate. Typically, the photosensitive glass substrate contains many metal elements such as lithium, silver and cerium, or metal ions in the form of a metal oxide in addition to silicon dioxide. One non-imitating example is used to illustrate the components of the photosensitive glass substrate as follows. A photosensitive glass substrate contains, based on the total weight of the photosensitive glass substrate, 75 to 85 wt % of silicon dioxide, 7 to 11 wt % of lithium oxide, 3 to 6 wt % of potassium oxide, 3 to 6 wt % of aluminum oxide, 1 to 2 wt % of sodium oxide, less than 2 wt % of zinc oxide, 0.2 to 0.4 wt % of antimony oxide (Sb₂O₃), 0.05 to 0.15 wt % of silver oxide and 0.01 to 0.04 wt % of cerium oxide (CeO₂). In this photosensitive glass substrate, the doped cerium ions therein are used as a photosensitizer and release electrons to silver ions after absorbing the energy from femtosecond laser pulses, such that the silver ions are transformed into silver atoms. It should be noted that the energy of first femtosecond laser pulses of the present invention used to modify the photosensitive glass substrate is adjusted to a suitable extent, and then the first femtosecond laser pulses are focused on the predetermined region, such as a surface or the interior, of the photosensitive glass substrate by a focus lens to define a modified region, such that the photosensitive glass substrate receives a laser intensity ranging between 0.2 and 2 J/cm² to transform the silver ions into silver atoms. However, because the energy received by the regions that are out of focus of the laser is insufficient, no reaction occurs in the non-focused regions of the photosensitive glass substrate (i.e. no silver atoms are formed). For example, when the interior of the photosensitive glass substrate is modified, the surface thereof is out of focus, and thus the surface will not be modified by the first femtosecond laser pulses (i.e. no silver atoms will be formed) and no crystals will not produced during tempering treatment.

In the second step of the method of the present invention, the second femtosecond laser pulses that have a frequency higher than that of the first femtosecond laser pulses are focused on the modified region of the photosensitive glass substrate, such that the substance of the modified region is crystallized. In this step, similarly, the same lens focuses the second femtosecond laser pulses and the focused pulses are allowed to scan along the trace of the first femtosecond laser pulses for modification. When the frequency (f) of the second femtosecond laser pulses is adjusted to be higher than that of the first femtosecond laser pulses, the thermal cumulative effect generated by femtosecond laser pulses heats the scanned modified region to produce crystals. In the present application, the frequency of the second femtosecond laser pulses is higher than that of the first femtosecond laser pulses, and preferably, the frequency of the second femtosecond laser pulses conforms to the following formula:

f≧Dₜ/d², wherein f is the frequency of the second femtosecond laser pulses, Dₜ is a thermal diffusion coefficient of the photosensitive glass substrate and d is a diameter of a laser spot of the second femtosecond laser pulses focused on the photosensitive glass substrate. Dₜ can be obtained from the formula: Dₜ=κ/ρCp, wherein κ is a thermal conduction coefficient (W/m·K) of a photosensitive glass substrate; ρ is the density (kg/m3) of a photosensitive glass substrate; and Cp is specific heat (J/(Kg·K) of a photosensitive glass substrate).

For example, when the frequency of the second femtosecond laser pulses is higher than the value obtained from the formula (Dₜ/d²), it will be the case that silver atoms in the scanned modified region aggregate to be of a silver atomic group (Agₓ) and that Li₂SiO₃ crystals are produced around the silver atomic group. In the step of thermal treatment to produce crystals (i.e. the step of focusing the second femtosecond laser pulses), when d is 5 μm, the frequency of the second femtosecond laser pulses is usually higher than 2.59 MHz. Energy of the second femtosecond laser pulses is adjusted to allow a laser intensity on the photosensitive glass substrate to range between 0.01 and 0.2 J/cm².

Because the speed of the crystallized region responsive to an acid solution is 20-40 times faster than that of the unmodified region, which is not modified and tempered, in the last step, the crystallized region is etched off to obtain the microstructure of the present invention. In an embodiment, a hydrofluoric acid solution is used in etching and ultrasonic vibration is used to accelerate the etching.

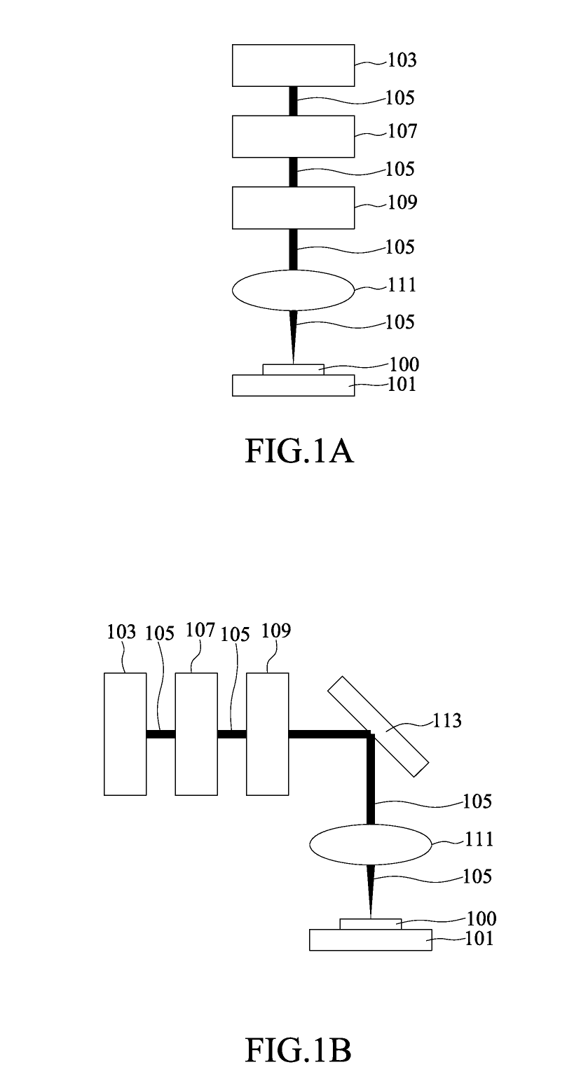

In addition, the present invention also provides a system for manufacturing a microstructure in a photosensitive glass substrate. As shown in FIG. 1A, the system includes: a carrier 101 for loading a photosensitive glass substrate 100; a femtosecond laser source 103 for generating femtosecond laser pulses 105; and a frequency adjustment unit 107, which is configured along a transmission path of the femtosecond laser pulses 105 to adjust the frequency of the femtosecond laser pulses 105; an energy adjustment unit 109, which is set up along the transmission path of the femtosecond laser pulses to adjust the energy of the femtosecond laser pulses 105; and a focus lens 111 for focusing the femtosecond laser pulses 105 with adjusted frequency and energy onto a surface or the interior of the photosensitive glass substrate 100. It should be noted that the setup of the frequency adjustment unit 107 and the energy regulation unit 109 in the present invention are not limited in order, such that it is also possible to adjust the energy first and then adjust the frequency.

In another embodiment shown in FIG. 1B, the system for manufacturing a microstructure in a photosensitive glass substrate further includes a reflective mirror 113 for changing a direction of a light path of the femtosecond laser pulses 105. As the example shown in FIG. 1B, the direction of the light path of the femtosecond laser pulses 105 changes about 90°.

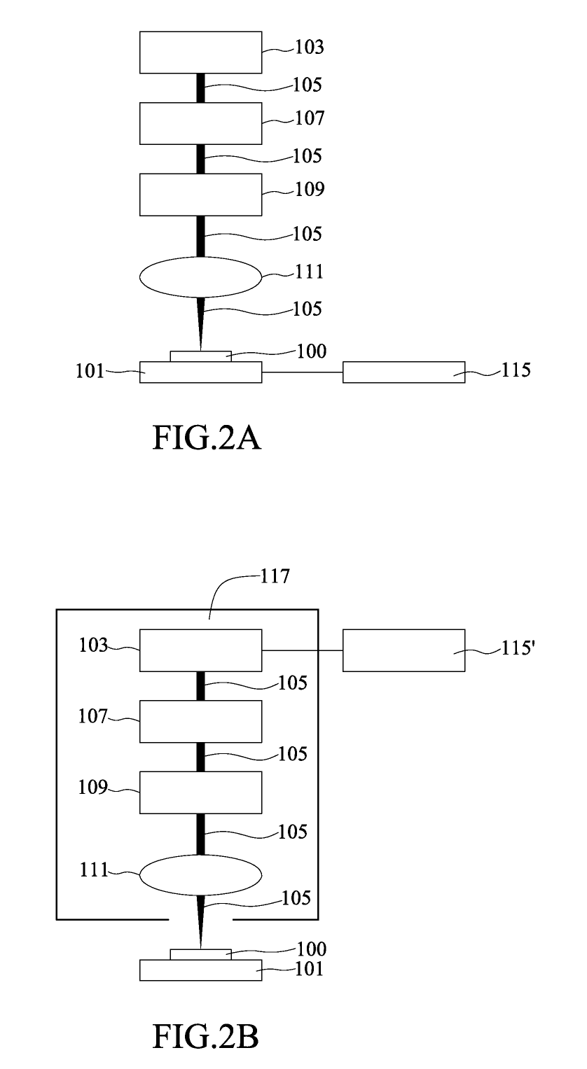

Referring to another embodiment shown in FIG. 2A, a system of the present invention further includes a movement control mechanism 115, which is connected to the carrier 101 to move the carrier 101 relative to the femtosecond laser pulses 105 and facilitates the formation of the microstructure. Since there are many examples of the movement control mechanism 115 known to those skilled in the art, it is not further described herein.

Further referring to another embodiment shown in FIG. 2B, a system of the present invention further includes a movement control mechanism 115′, which is connected to the femtosecond laser source 103 to allow the femtosecond laser pulses 105 to move relative to the carrier 101 to form a modified pattern and a crystallized pattern. In practice, as shown in FIG. 2B, the femtosecond laser source 103, the frequency adjustment unit 107, the energy adjustment unit 109 and the focus lens 111 can be installed in a casing 117, and the movement control mechanism 115′ is connected to the casing and/or the femtosecond laser source 103 to control the movement of the femtosecond laser pulses 105 on the photosensitive glass substrate 100. Certainly, the femtosecond laser source 103, the frequency adjustment unit 107 and the energy adjustment unit 109 can be simply fastened to each other by connectors as long as the frequency adjustment unit 107 and the energy adjustment unit 109 are configured along the transmission path of the femtosecond laser pulses 105.

### Example 1

### Manufacture of Surface Microstructure in Photosensitive Glass Substrate

In this example, the femtosecond laser pulses with a frequency of 1 kHz and energy of 0.2 mW were focused on the surface of a photosensitive glass substrate by a 10× objective lens to modify the surface with a scanning speed of 0.05 mm/s to define a modified region. Then, the second femtosecond laser pulses with a frequency of 80 MHz and energy of 300 mW were focused on the surface of the photosensitive glass substrate by a 50× objective lens and the second focused femtosecond laser pulses scanned the modified region of the photosensitive glass substrate with a speed of 0.5 mm/s for the tempering treatment. Finally, the crystallized region was removed by 8% of hydrofluoric acid accompanied with ultrasonic vibration for 15 minutes.

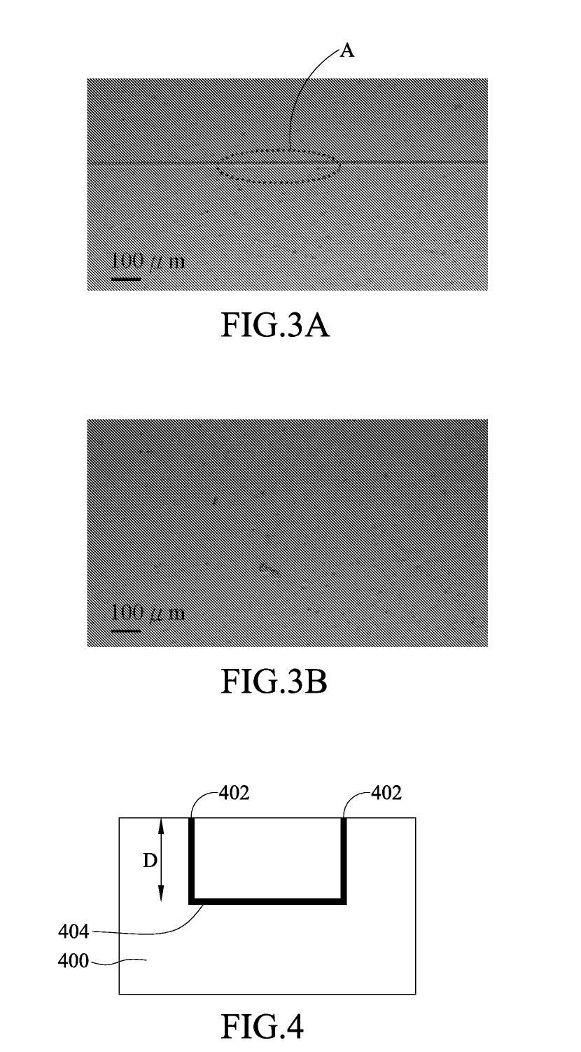

As shown in FIG. 3A, the position circled by the dotted line A shows that a groove is formed by the method of Example 1. However, as shown in FIG. 3B, if tempering is performed by femtosecond laser pulses with a frequency less than the value obtained from Dₜ/d², the groove is not be formed.

### Example 2

### Manufacture of Blind Via of Photosensitive Glass Substrate

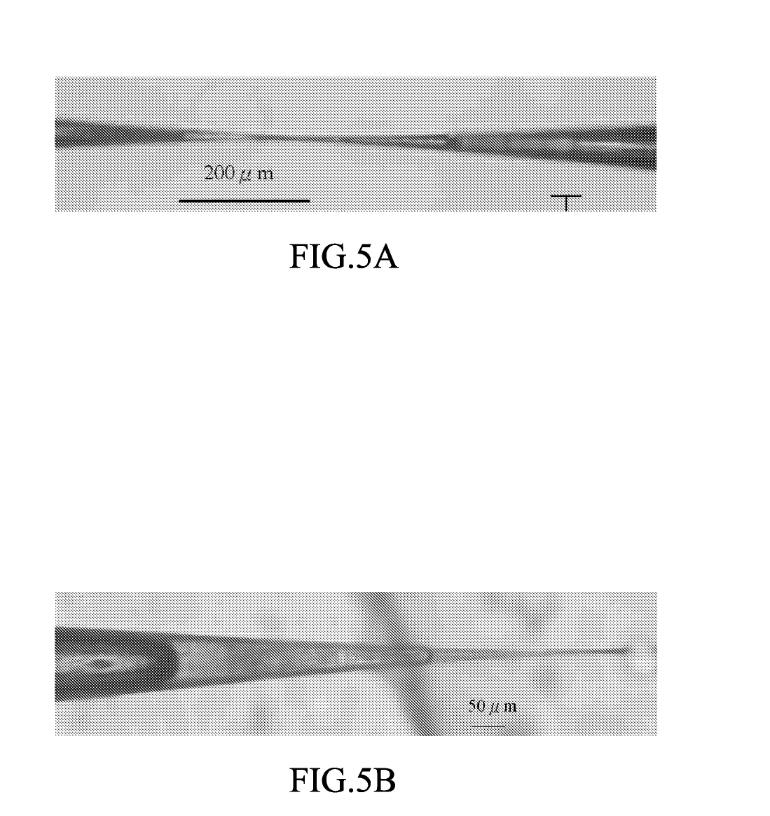

In this example, femtosecond laser pulses with a frequency of 1 kHz and energy of 0.255 mW were focused on the interior of a photosensitive glass substrate by a 10× objective lens for modification, wherein, as shown in FIG. 4, in order to form modified regions of pits 402 at two positions of the surface of the photosensitive glass substrate 400, the femtosecond laser pulses scanned from the surface of the photosensitive glass substrate down to a depth (D) of 0.2 mm at the predetermined two ends of a blind via at a speed less than 0.5 mm/s, such as 0.05 mm/s. The micro-channel 404 connected between the pits 402 of the photosensitive glass substrate was scanned by a speed of 0.5 mm/s to form a U-shaped modified region. Then, the femtosecond laser pulses with a frequency of 80 MHz and energy of 330 mW were focused on the interior of the photosensitive glass substrate by a 50× objective lens and scanned the modified region of the photosensitive glass substrate with the above-mentioned speed for the tempering treatment. Finally, the crystallized region was removed by an 8% hydrofluoric acid solution accompanied with ultrasonic vibration for 15 minutes.

As shown in FIG. 5A, after etching about 49 minutes, the micro-channel of this example was formed. As shown in FIG. 5B, the thinnest part in the middle section of the micro-channel is about 5 μm.

Based on the above, it is known that a microstructure can be rapidly manufactured on a surface or the interior of a photosensitive glass substrate by the method and system of the present invention. Further, the thinnest and most precise patterns and micro-channels can be obtained under the conditions disclosed in the present invention.

The foregoing descriptions of the detailed embodiments are illustrated to disclose the principles and functions of the present invention and are not intended to restrict the scope of the present invention. It should be understood by those in the art that many modifications and variations can be made according to the spirit and principles in the disclosure of the present invention and yet fall within the scope of the appended claims. The specification and examples are considered as exemplary only, with the true scope of the invention being indicated by the following claims.

What is claimed is:

1. A method for manufacturing a microstructure in a photosensitive glass substrate, comprising:
focusing first femtosecond laser pulses on a surface or the interior of the photosensitive glass substrate to define a modified region;
focusing second femtosecond laser pulses having a frequency higher than that of the first femtosecond laser pulses on the modified region to crystallize a substance of the modified region; and
after the step of focusing second femtosecond laser pulses, etching off the crystallized region to obtain the microstructure.

2. The method of claim 1, wherein the first femtosecond laser pulses and the second femtosecond laser pulses are generated by a femtosecond laser source, and the pulse widths of the first femtosecond laser pulses and the second femtosecond laser pulses are smaller than or equivalent to 500 fs.

3. The method of claim 1, further comprising:
adjusting the energy of the first femtosecond laser pulses before the step of focusing the first femtosecond laser pulses to allow the laser intensity of the first femtosecond laser pulses focused on the photosensitive glass substrate to rang between 0.2 and 2 J/cm².

4. The method of claim 1, wherein the first femtosecond laser pulses and the second femtosecond laser pulses are focused by a lens.

5. The method of claim 1, wherein the frequency of the second femtosecond laser pulses conforms to the following formula:
f≧Dₜ/d²,
wherein f is the frequency of the second femtosecond laser pulses, Dₜ is a thermal diffusion coefficient of the photosensitive glass substrate and d is a diameter of a laser spot of the second femtosecond laser pulses focused on the photosensitive glass substrate.

6. The method of claim 5, wherein the laser intensity of the focused second femtosecond laser pulses on the photosensitive glass substrate ranges between 0.01 and 0.1 J/cm².

7. The method of claim 1, wherein the photosensitive glass substrate contains silicon dioxide and metal oxides of lithium, silver and cerium.

8. The method of claim 7, wherein the step of focusing the first femtosecond laser pulses allows an atom type silver to be formed in the modified region.

9. The method of claim 7, wherein the step of focusing the second femtosecond laser pulses allows a Li₂SiO₃ crystal to be formed in the modified region.

10. The method of claim 9, wherein the frequency of the second femtosecond laser pulses conforms to the following formula:
f≧Dₜ/d²
wherein f is the frequency of the second femtosecond laser pulses, Dₜ is a thermal diffusion coefficient of the photosensitive glass substrate and d is a diameter of a laser spot of the second femtosecond laser pulses focused on the photosensitive glass substrate.

11. The method of claim 1, wherein the step of etching off the crystallized region is performed by a hydrofluoric acid solution.

12. The method of claim 1, wherein the first femtosecond laser pulses have a frequency of 1 kHz and energy of 0.2 mW and are focused by a 10× objective lens and the focused first femtosecond laser pulses scan the surface of the photosensitive glass substrate with a scanning speed of 0.05 mm/s.

13. The method of claim 1, wherein the second femtosecond laser pulses have a frequency of 80 MHz and energy of 300 mW and is focused by a 50× objective lens, and the focused second femtosecond laser pulses scan the modified region with a scanning speed of 0.5 mm/s.

14. The method of claim 1, wherein the first femtosecond laser pulses have a frequency of 1 kHz and energy of 0.255 mW and are focused by a 10× objective lens, and the focused first femtosecond laser pulses scan the interior of the photosensitive glass substrate with a scanning speed less than 0.5 mm/s.

15. The method of claim 14, wherein the second femtosecond laser pulses have a frequency of 80 MHz and energy of 300 mW and are focused by a 50× objective lens, and the focused second femtosecond laser pulses scan the modified region with a scanning speed of 0.5 mm/s.

16. A system for manufacturing a microstructure in a photosensitive glass substrate, comprising
a carrier;
a femtosecond laser source for generating femtosecond laser pulses;
a frequency adjustment unit configured along a transmission path of the femtosecond laser pulses to adjust frequency of the femtosecond laser pulses;
an energy adjustment unit configured along the transmission path of the femtosecond laser pulses to control energy of the femtosecond laser pulses; and
a focus lens for focusing the femtosecond laser pulses with adjusted frequency and energy on a surface or the interior of the photosensitive glass substrate loaded on the carrier.

17. The system of claim 16, further comprising a movement control mechanism connected to the carrier to move the carrier relative to the femtosecond laser pulses.

18. The system of claim 16, further comprising a movement control mechanism connected to the femtosecond laser source to allow the femtosecond laser pulses to move relative to the carrier, thereby forming a modified pattern and a crystallized pattern.

19. The system of claim 16, further comprising a reflective mirror for changing the direction of the light path of the femtosecond laser pulses.

20. The system of claim 16, wherein the femtosecond laser source, the frequency adjustment unit and the energy adjustment unit are fastened to each other.
